(19) United States
(12) Patent Application Publication
(10) Pub. No.: US 2014/0047354 A1
(43) Pub. Date: Feb. 13, 2014

(54) TRANSPORTATION SHARING BASED ON MAP LOCATIONS

(71) Applicant: Murali Karamchedu, Beaverton, OR (US)

(72) Inventor: Murali Karamchedu, Beaverton, OR (US)

(73) Assignee: TollShare, Inc., Danville, CA (US)

(21) Appl. No.: 13/584,668

(22) Filed: Aug. 13, 2012

(51) Int. Cl. G06F 3/01

(52) U.S. Cl. 715/753

(57) ABSTRACT

In embodiments, a map-based shared transportation location identification module (“MTSS”) may facilitate display of locations on a map for which shared transportation has been indicated as being offered or willing to be accepted. In embodiments, the MTSS may identify locations for which shared transportation has been indicated and display those on top of a map; the map may be displayed by the same logical entity as the MTSS or by a different entity. The MTSS may allow a user to select one or more of the locations, view information view information related to the location and elect to accept the offer (or to provide their own offer). The MTSS may then facilitate a matching of the user with the other relevant user for the purpose of sharing transportation. Other embodiments may be described.

### BACKGROUND

As populations grow, transportation issues continue to loom larger and larger in the minds of people who live in populous communities. In some circumstances, people use mass transit to arrive at destinations. However, many mass transit solutions are inflexible in both their routes and schedules, frustrating riders.

As another solution, some people may utilize user-provided transportation sharing to get from place to place. For example, people may organize carpools or other ride-sharing systems to spread the cost of a drive amongst multiple people. Additionally, by working with other individuals who have similar transportation goals and/or interests, many people may find transportation solutions that are better tailored to their particular needs.

However, some current user-provided shared transportation models do not provide easy mechanisms for riders (and drivers) to identify opportunities for sharing user-provided transportation. Many times, potential riders must make direct appeals, such as in advertising or message boards, to find similarly-situated individuals with whom they can share rides. Such solutions introduce inefficiencies that make user-provided transportation sharing difficult and slow its adoption.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 illustrates an example map-based shared transportation location identification system (“MTSS”), in accordance with various embodiments.

FIG. 2 illustrates an example map including identification of shared-transportation locations by the MTSS, in accordance with various embodiments.

FIG. 3 illustrates an example map-based shared transportation location identification process, in accordance with various embodiments.

FIG. 4 illustrates an example map-based shared transportation location display process, in accordance with various embodiments.

FIG. 5 illustrates an example map-based shared transportation location interaction receipt process, in accordance with various embodiments.

FIG. 6 illustrates an example map-based shared transportation location interaction process, in accordance with various embodiments.

FIG. 7 illustrates an example map-based shared transportation location creation process, in accordance with various embodiments.

FIG. 8 illustrates an example system for utilization of a shared-transportation user-interface element, in accordance with various embodiments.

FIG. 9 illustrates an example shared-transportation user-interface element usage process, in accordance with various embodiments.

FIG. 10 illustrates an example shared-transportation user-interface element provision process, in accordance with various embodiments.

FIG. 11 illustrates an example shared-transportation user-interface element display process, in accordance with various embodiments.

FIG. 12 illustrates an example shared-transportation user-interface element request process, in accordance with various embodiments.

FIG. 13 illustrates an example shared-transportation social interaction system, in accordance with various embodiments.

FIG. 14 illustrates an example shared-transportation social interaction process, in accordance with various embodiments.

FIG. 15 illustrates an example social shared-transportation follower association process, in accordance with various embodiments.

FIG. 16 illustrates an example social shared-transportation location determination process, in accordance with various embodiments.

FIG. 17 illustrates an example social shared-transportation location notification process, in accordance with various embodiments.

FIG. 18 illustrates an example computing environment suitable for practicing the disclosure, in accordance with various embodiments.

### DETAILED DESCRIPTION

In the following detailed description, reference is made to the accompanying drawings which form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

As used herein, the term “module” may refer to, be part of, or include an Application Specific Integrated Circuit (“ASIC”), an electronic circuit, a processor (shared, dedicated, or group) and/or memory (shared, dedicated, or group) that execute one or more software or firmware programs, a combinational logic circuit, and/or other suitable components that provide the described functionality.

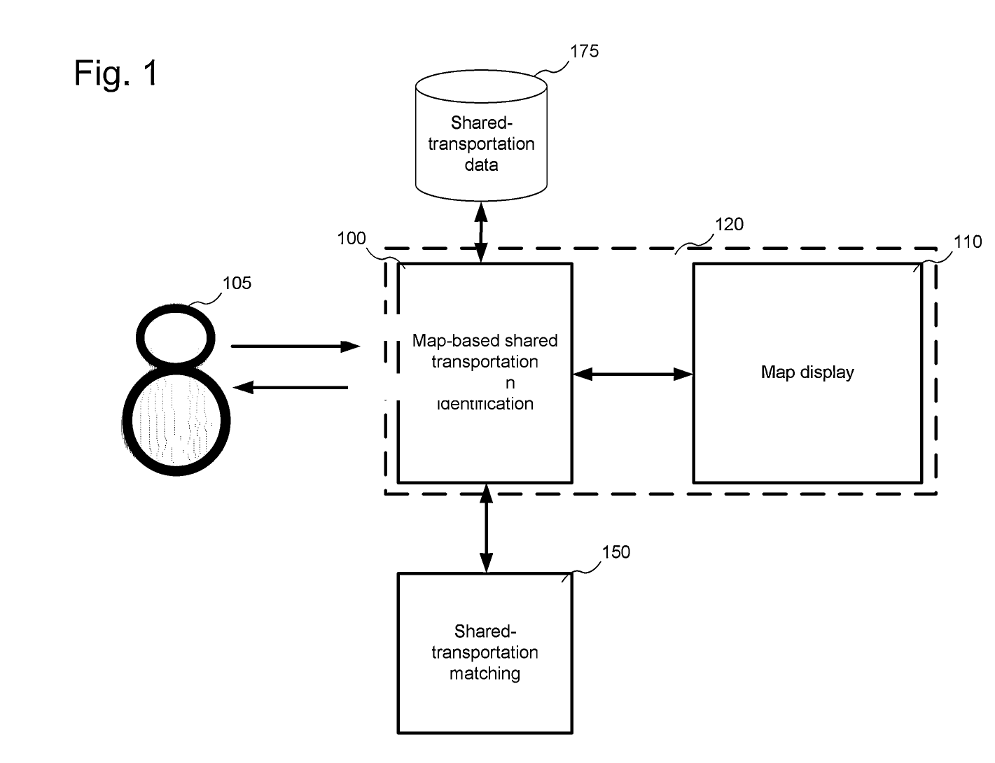

Referring now to FIG. 1, a map-based shared transportation location identification system 100 (“MTSS 100”) is illustrated. In various embodiments, the MTSS 100 may be configured to illustrate, on a computer-generated map (such as on a website) one or more locations that a user 105 may select for transportation sharing. In various embodiments, the user 105 may interact with the map in order to select displayed locations for transportation sharing or to identify new locations for transportation sharing. Thus, in various embodiments, the user 105 may click on the map and indicate that he or she wishes to share a ride to that location. In various embodiments, the user 105 may be either a provider of a ride or a person wishing to receive a ride. In various embodiments, by providing a facility to view shared transportation opportunities on a map, the MTSS 100 may facilitate users in identifying and utilizing shared transportation on an efficient basis.

In various embodiments, the MTSS 100 may also be configured to facilitate transportation sharing to one or more events found at locations. It may be assumed herein that a “location” may optionally include an event at that location, and that data referring to a location may optionally include data referring to an event.

As discussed above, in various embodiments, the MTSS 100 may be configured, after receiving a selection of a location on the map, to facilitate association of the location with an indication to offer or accept user-provided transportation to the location. Thus, in various embodiments, the MTSS 100 may be configured to interact with a shared-transportation matching module 150. In embodiments, the MTSS 100 may be configured to additionally provide an interface for obtaining additional information about the user 105 in order to facilitate shared-transportation matching activities of the shared-transportation matching module 150. Thus, for example, after the user 110 selects a location, the MTSS 100 may display an interface requesting whether the user 110 wishes to offer or accept transportation, as well as receiving other information about the user 110 or the user 110's preferences with regard to the location and/or transportation. In various embodiments, other entities may create or interact with locations displayed on the map. For example, a sponsor of an event or a vendor with a place of business may create a location on the map for users to interact with and share transportation to.

In various embodiments, the one or more locations displayed on the map may be obtained by the MTSS 100 through interactions with a shared-transportation data storage 175. In various embodiments, the shared-transportation data storage 175 may additionally store information about the user 110 for use by the shared-transportation matching module 150. In various embodiments, the shared-transportation data storage 175 may include one or more databases, hard drives, networked storage devices, and/or other storage devices.

In various embodiments, one or more maps may be displayed for the user 105 by a map display module 110. In various embodiments, the map display module 110 and the MTSS 100 may be configured as part of a combined logical entity 120. For example, the MTSS 100 and the map display module 110 may be configured as part of a application or mobile app. In other embodiments, the MTSS 100 and the map display module 110 may be separate. Thus, in some embodiments, the MTSS 100 may be configured as a plug-in to a browser, with the browser acting as the map display module 110. In some such embodiments, the map may be provided by the browser navigating to a website containing a map.

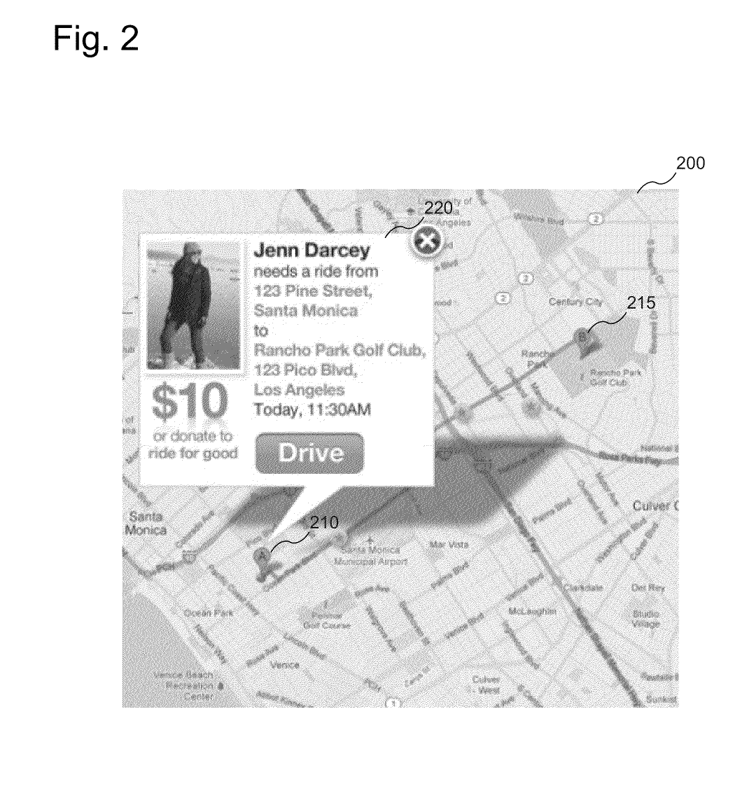

FIG. 2 illustrates an example map 200 including identification of shared-transportation locations by the MTSS 100, in accordance with various embodiments. As illustrated in the example, the map 200 may display one or more locations for which users have indicated that they wish to offer or accept shared transportation, such as locations 210 and 215. In the illustrated embodiment, the map also shows an interface 220, which displays information for a ride a user is willing to accept. As illustrated, the interface may display such info as an identification of the user, a starting point, an ending point, and an amount the user is willing to pay for the ride. As illustrated, the interface 220 may also provide a user interface element for a user viewing the interface to offer shared transportation to the other user. In other embodiments, additional information may be included in the interface 220.

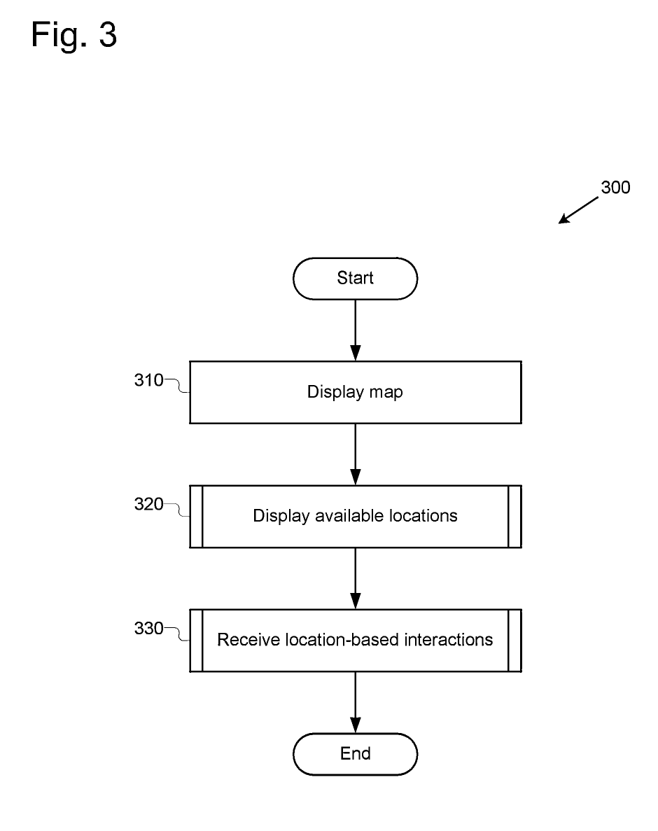

FIG. 3 illustrates an example map-based shared transportation location identification process 300, in accordance with various embodiments. In various embodiments, the process may begin at operation 310, where a map may be displayed to the user 110, such as by the map display module 110. Next, at operation 320, the MTSS 100 may display available locations on the map. Particular embodiments of operation 320 are discussed below. Next, at operation 330, the MTSS 100 may receive location-based interactions with the map. For example, the MTSS 100 may receive interactions to select an available location or to create a new location on the map. Particular embodiments of operation 330 are discussed below. The process may then end.

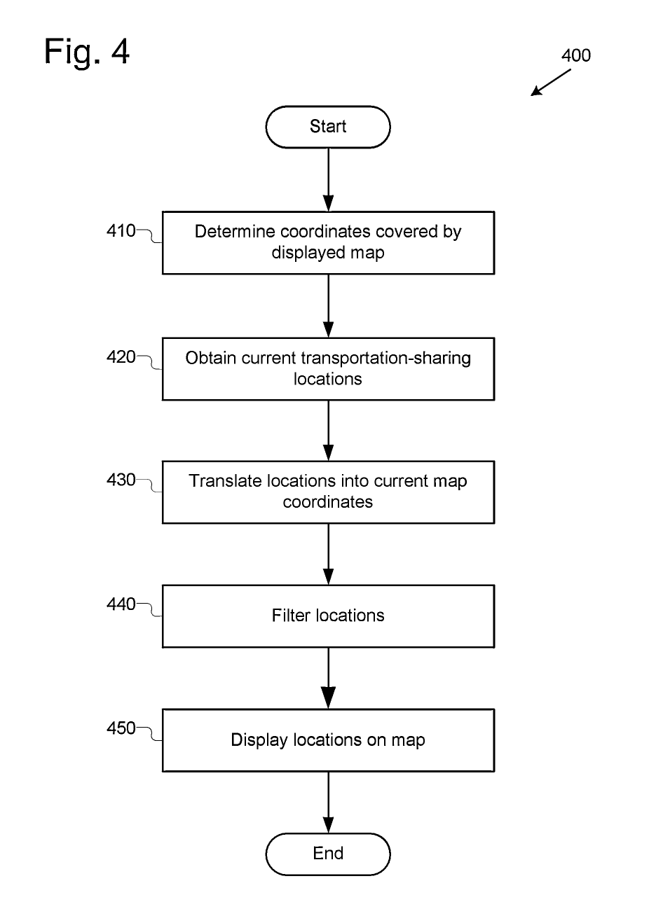

FIG. 4 illustrates an example map-based shared transportation location display process 400, in accordance with various embodiments. In various embodiments, process 400 may include one or more implementations of operation 320 of process 300. The process may begin at operation 410 where, in various embodiments, the MTSS 100 may analyze the map displayed at operation 310 in order to determine coordinates covered by the map. Next, at operation 420, in various embodiments, the MTSS 100 may determine current shared-transportation locations. In various embodiments, the MTSS 100 may obtain data from the shared-transportation data storage 175 describing one or more locations for which users have previously indicated that they wish to offer or accept transportation to. In various embodiments, the MTSS 100 may obtain data about locations only which are to be found in the coordinates determined at operation 410. In other embodiments, the MTSS 100 may perform other searches, such as by address or keyword, to obtain location data.

Next, at operation 430, the MTSS 100 may translate the locations into coordinates for the map displayed at operation 310. Then, at operation 440, the MTSS 100 may filter the locations based on one or more criteria of the user 105. For example, the user 105 may wish to only see locations that are related to the user 105s interests. In another example, the MTSS 100 may filter to show the user 105 only locations for which transportation is currently being offered. In yet another embodiment, at operation 440, the MTSS 100 may filter the locations based on one or more friend or follower associations between the user 105 and other users of the MTSS 100.

Next, at operation 450, the MTSS 100 may display the locations on the map. In various embodiments, the locations may be displayed with markers or other indicia. In various embodiments, the locations may be displayed along with additional data about an indication by a user to offer and/or accept transportation to the location. For example, the interface 220 of FIG. 2 displays additional information about an indication to accept transportation to a location. The process may then end.

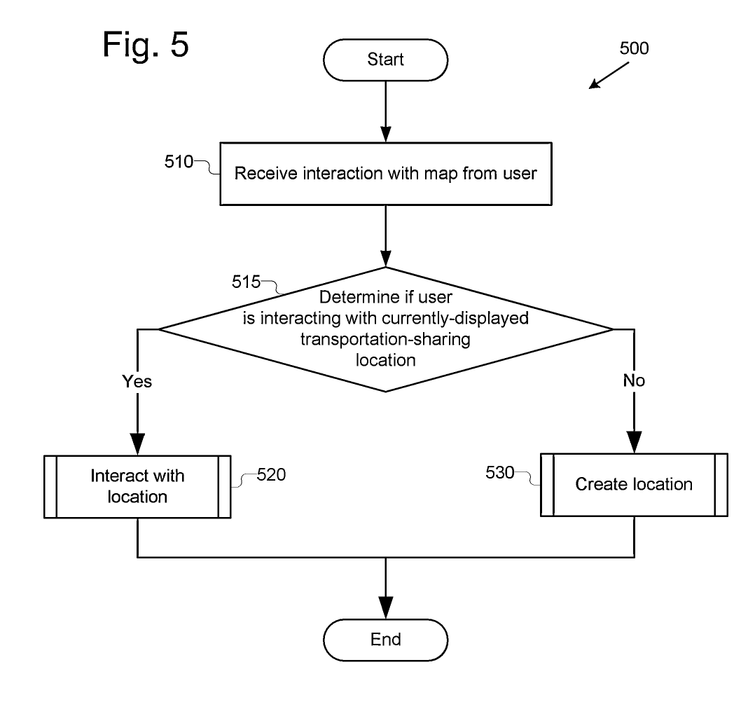

FIG. 5 illustrates an example map-based shared transportation location interaction receipt process 500, in accordance with various embodiments. In various embodiments, process 500 may include one or more implementations of operation 330 of process 300. The process may begin at operation 510, where the MTSS 100 may receive interaction with the map from a user. In various embodiments, operation 510 may include direct selection or other interaction with a mobile app that includes MTSS 100. In other embodiments, such as when MTSS 100 include a browser plug-in, operation 510 may include, in part, receipt of one or more interaction event notifications (e.g., click, drag, select) from an operating system or other user interface system.

Next, at decision operation 515, the MTSS 100 may determine, in various embodiments, whether the user 105 is interacting with a currently-displayed shared-transportation location and/or event, such as one displayed during process 400. If the MTSS 100 determines that the user 105 is interacting with a displayed location, then at operation 520, the MTSS 100 may allow the user 105 to interact with the selected location. Particular embodiments of operation 520 are discussed below. If, however, the MTSS 100 determines at decision operation 515 that the user is not interacting with a displayed location, then at operation 530, the MTSS 100 may allow the user 105 to create a location. Particular embodiments of operation 530 are discussed below. The process may then end.

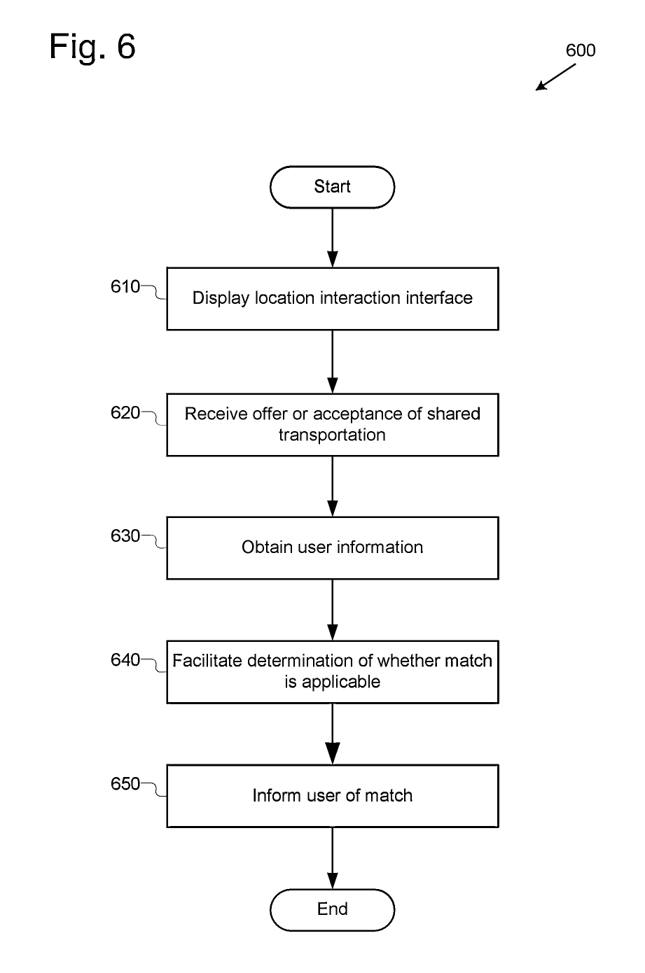

FIG. 6 illustrates an example map-based shared transportation location interaction process 600, in accordance with various embodiments. In various embodiments, process 600 may include one or more implementations of operation 520 of process 500. The process may begin at operation 610, where the MTSS 100 may display a location interaction interface, such as, for example, interface 220 of FIG. 2. As discussed above, the interface 220 may contain information about the location, including whether the location was displayed resulting from an indication by a user to offer or to accept transportation to the location. In other embodiments, the MTSS 100 may display a routing-style interface at operation 610 that includes the ability to share transportation to the location amongst one or more routing options. For example, the MTSS 100 may display, to the user 105, routing options such as “by car,” “by public transit,” “by foot.” The MTSS 100 may also display an option, such as “by ride share” that allows the user 105 to select that he or she would like to travel to the location through shared transportation. Next, at operation 620, the MTSS 100 may receive an offer or acceptance of shared transportation from the user 105. For example, in the example interface 220 of FIG. 2, the user may click on the “Drive” user interface element to indicate an offer to provide shared transportation. In various embodiments, operation 620 may include receipt of a selection by the user 105 to share transportation from amongst various routing options, as described above.

Next, at operation 630, the MTSS 100 may obtain user information for the user 105. In some embodiments, the MTSS 100 may provide an interface for the user 105 to enter user information. In other embodiments, information about the user 105 may be previously known to the MTSS 100 and may be stored, such as on the shared-transportation data storage 175. Next at operation 640, the MTSS 100 may facilitate a determination, such as by the shared-transportation matching module 150, of whether a match is applicable between the user 105 and a user with whom the user 105 may be sharing transportation. In various embodiments, the shared-transportation matching module 150 may utilize the previously-obtained user information about user 105 to perform the match. In various embodiments, the determination by the shared-transportation matching module 150 may be done with relation to one or more criteria, including, but not limited to: user ratings, user preferences, user locations, user transportation history, friendships, social networking follower associations, and others. Next, at operation 650, the MTSS 100 may inform the user 105 of whether a match was determined by the shared-transportation matching module 150 at operation 640. If a match is made, the user 105 may utilize this notification to proceed with the shared transportation. The process may then end.

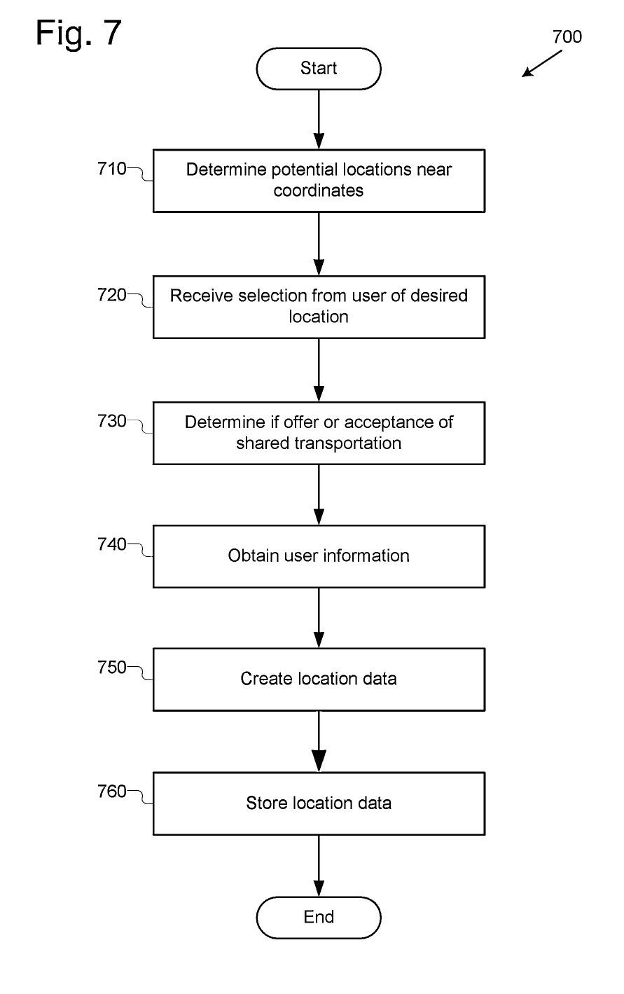

FIG. 7 illustrates an example map-based shared transportation location creation process 700, in accordance with various embodiments. In various embodiments, process 700 may include one or more implementations of operation 530 of process 500. The process may begin at operation 710, where the MTSS 100 may determine potential locations near the coordinates selected by the user 105. Next, at operation 720, the MTSS 100 may receive a selection of a desired location from those locations determined at operation 710. In various embodiments, at operation 720 the MTSS 100 may display one or more locations for the user 105 to select from. In other embodiments, the MTSS 100 may display an address near the selected coordinates and ask the user 105 to confirm or to correct the address. In some embodiments, at operation 720 the MTSS 100 may display a routing-style interface, such that that described above, that includes the ability to share transportation to the selected location. In various embodiments, the routing interface may include an option, such as “by ride share” that allows the user 105 to select that he or she would like to travel to the selected location through shared transportation. Thus, in various embodiments, operation 720 may include receipt of a selection by the user 105 to share transportation from amongst various routing options, as described above. Next, at operation 730, the MTSS 100 may determine if the user 105 wishes to indicate that the user 105 wants to offer or to receive shared transportation to the selected location. Next, at operation 740, the MTSS 100 may obtain user information for the user 105. In some embodiments, the MTSS 100 may provide an interface for the user 105 to enter user information. In other embodiments, information about the user 105 may be previously known to the MTSS 100 and may be stored, such as on the shared-transportation data storage 175. Next, at operation 750, the MTSS 100 may create location data for the selected location. In various embodiments, the created data may include information about the location, the user 105, the indication made by the user 105 about whether the user 105 wishes to offer or accept shared transportation, and other information. Next, at operation 760, the MTSS 100 may store the location data for later display to other users. In various embodiments, the MTSS 100 may store the data on the shared-transportation data storage 175. The process may then end.

The following examples may illustrate particular uses of the MTSS 100 to facilitate sharing of transportation. It may be recognized that no particular limitation is implied by these examples and that other embodiments may be described and claimed.

In one example, a user 105 may install a copy of the MTSS 100 as part of an app running on a mobile device. The user 105 may view a map displayed by the MTSS 100 on the mobile device (such as by map display module 110 executing as part of the mobile device. The MTSS 100 may display multiple locations on the displayed map for which other users have either indicated that they would like to offer shared transportation or to accept an offer of shared transportation. The user 105 may then select one of these locations, view information related to the location, such as that stored in the shared transportation data storage 175, and elect to accept the offer (or to provide their own offer). The MTSS 100 may then facilitate a matching of the user with the other relevant user, such as by using the shared transportation matching module 150.

In another example, the user 105 may install the MTSS 100 as a plugin to a browser. Upon viewing a map, such as by directing the browser to visit a mapping website, the MTSS 100 may display multiple locations on the displayed map, such as above. The MTSS 100 may then facilitate interaction with the user in a manner similar to that described herein.

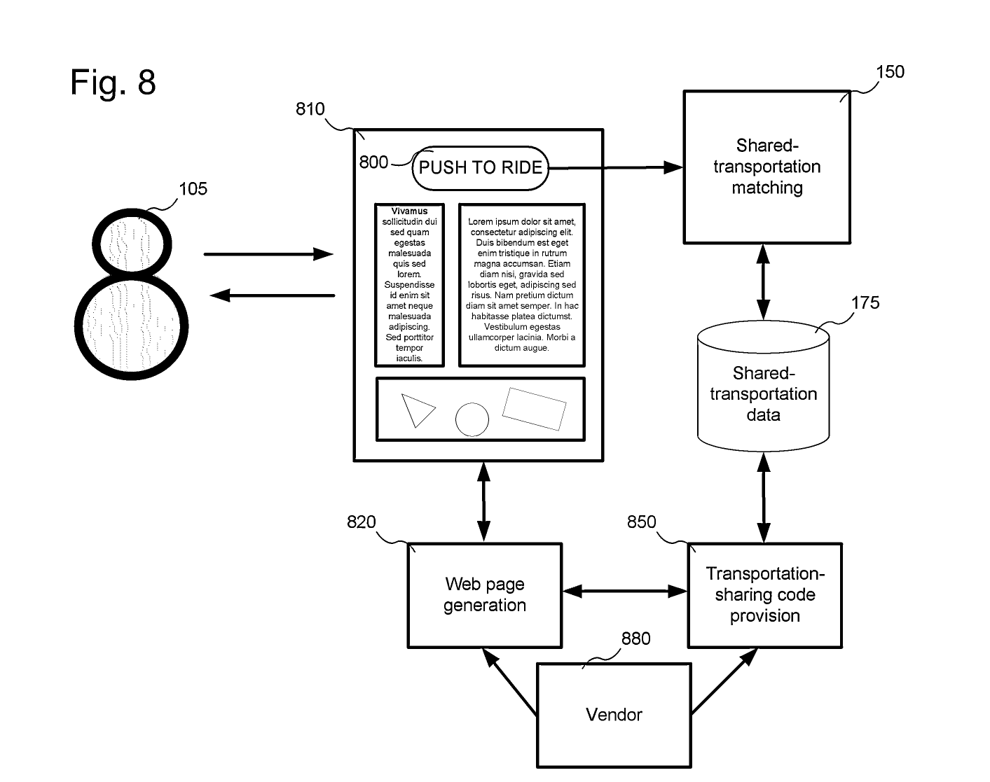

Referring now to FIG. 8, a system is shown for utilization of a shared-transportation user interface element 800 (“STE 800”). In various embodiments, the STE 800 may include a button or other user interface element contained in a web page 810 for selection by the user 105. In various embodiments, the STE 800 may be associated with a location described or otherwise associated with the web page 810 in order to provide the user 105 with a direct way to indicate that the user would like to share transportation to the location. This allows the creator of the web page to more easily facilitate the sharing of transportation to the location and to encourage users that visit the site to take advantage of shared transportation opportunities.

In various embodiments, an STE 800 may be included in the web page 810 by inclusion of code for the STE 800 in code for the web page 810. In various embodiments, the code for the STE 800 may be configured to perform and facilitate various shared transportation actions described herein; in some embodiments, activation of the STE 800 may cause additional code to be executed, either locally to the user, or remotely. In various embodiments, the STE 800 may be included in media or documents other than web pages, such as emails or social media communications.

In various embodiments, the code for the STE 800 may be provided, such as by the shared-transportation code provision module 850. The code for the STE 800 may then be given to a separate entity that creates the web page 810, such as web page generation module 820. In other embodiments, the web page 810 may contain one or more links or references to externally-sourced code for the STE 800, reducing the need for the shared-transportation code provision module 850 to provide code to the web page generation module 820.

In various embodiments, the web page generation module 820 may be under separate control from the shared-transportation code provision module 850. Thus, a web page creator or vendor (such as vendor 880, described below) may create a web page under its own control while including the code for the STE 800 separately created by the shared-transportation code provision module 850. In various embodiments, the shared-transportation code provision module 850 may be configured to respond to one or more requests or function calls to provide the STE 800. In various embodiments, the function calls may be performed through a public API. This API may be used, for example, by the web page generation module 820 or the vendor 880 to cause the shared-transportation code provision module 850 to provide the STE 800.

In various embodiments, the shared-transportation code provision module 850 may provide code for the STE 800 based at least in part on shared-transportation data stored on shared-transportation storage 175. Thus, for example, in some embodiments, the user 105 may be known to a browser requesting the web page 810. In such embodiments, the web page generation module 820 may request the code for the STE 800 with reference to the user 105. The shared-transportation code provision module 850 may then obtain data associated with the user 105, if such data is known to the shared-transportation data storage 175, and use the data in the creation of the STE 800 before providing the STE 800 to be included in the web page 810.

In alternate embodiments, the shared-transportation code provision module 850 may include a plug-in to a browser. In some such embodiments, the shared-transportation code provision module 850 may be configured to identify a location based on information in the web page 810 and to generate and display the STE 800 locally. In some embodiments, the shared-transportation code provision module 850 may be configured to communicate remotely with the shared-transportation data storage 175 to facilitate this local generation of the STE 800.

As mentioned above, in various embodiments, the STE 800 may be configured to facilitate association of the user 105 with the sharing of transportation to a location described in the web page 810. Thus, the user 105, while viewing the webpage 810, may determine that he or she wishes to accept transportation to a location described in the web page 810 and may select the STE 800 in order to do so. Upon selection, the code for the STE 800 may then initiate a matching of the user 105 with one or more offers of shared transportation by other users. This matching may be performed by the transportation sharing matching module 150.

In various embodiments, generation of the web page 810, as well as the STE 800, may be controlled by a vendor 880. The vendor 880 may, in various embodiments, have some degree of control over the location described in the web page 810 and for which the STE 800 is generated. Thus, if the vendor 880 is a restaurant, the vendor 880 may create a web page 810 describing the restaurant and may direct the shared-transportation code provision module 850 to provide the STE 800 to facilitate the sharing of transportation to the restaurant. In various embodiments, the vendor 880 may additionally secure offers for transportation to the location separately, so that there already exist offers of shared transportation for the user 105 when activating the STE 800. In other embodiments, the vendor 880 may determine one or more locations of other entities that are listed in its page. For example a vendor 880 running an auction site may include one or more STE 800s for sellers listed in its web page.

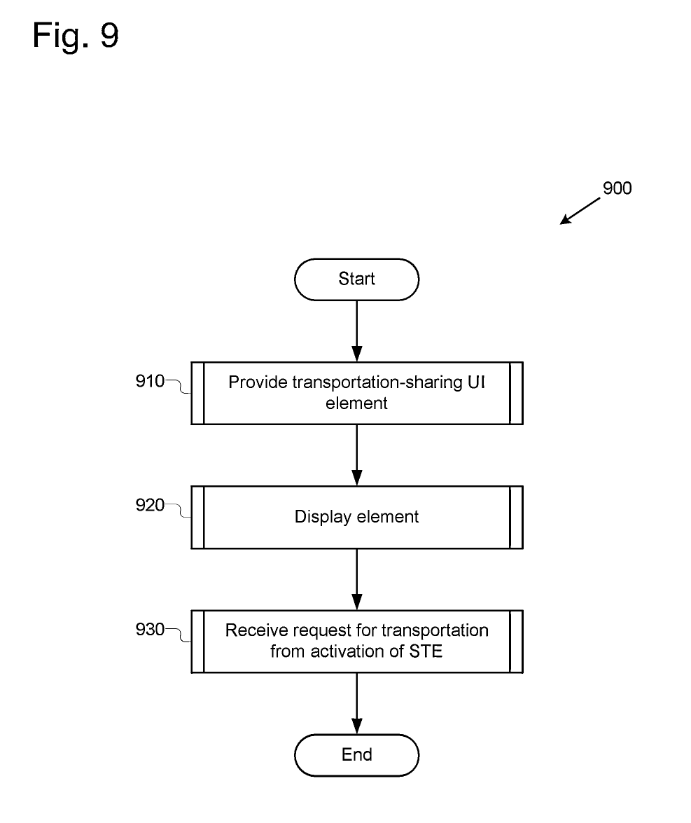

FIG. 9 illustrates an example shared-transportation user-interface element usage process 900, in accordance with various embodiments. The process may begin at operation 910, where the STE 800 may be provided, such as by the shared-transportation code provision module 850. Next, at operation 920, the STE 800 may be displayed to the user 105. Next, at operation 930, a request for shared transportation may be received through activation of the STE 800. The process may then end. Particular embodiments of operations 910, 920 and 930 are discussed below.

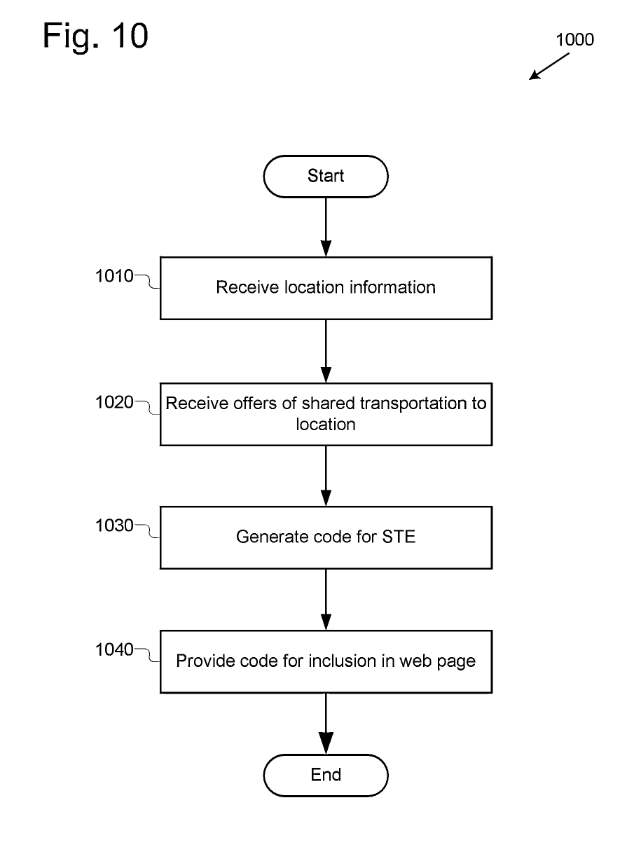

FIG. 10 illustrates an example shared-transportation user-interface element provision process 1000, in accordance with various embodiments. In various embodiments, process 1000 may include one or more implementations of operation 910 of process 900. The process may begin at operation 1010, where the shared-transportation code provision module 850 may receive information about a location for which the STE 800 may be provisioned. In various embodiments, the information about the location may be received from the vendor 880. In other embodiments, the information may be determined by the shared-transportation code provision module 850 based on information contained in the web page 810 (or to be contained in the web page 810 if it has not been created yet). Next, at operation 1020, the shared-transportation code provision module 850 may receive indications of one or more offers of shared transportation to the location.

In various embodiments, these offers may be obtained and provided to the shared-transportation code provision module 850 by the vendor 880. In other embodiments, the vendor may not pre-select offers of transportation, but instead may simply provision an STE 800 in order to facilitate users 105 to be matched to find shared transportation. Next, at operation 1030, the shared-transportation code provision module 850 may generate code for the STE 800. This generated code may be provisioned to the web page generation module 820 at operation 1040 for inclusion in the web page 810. The process may then end.

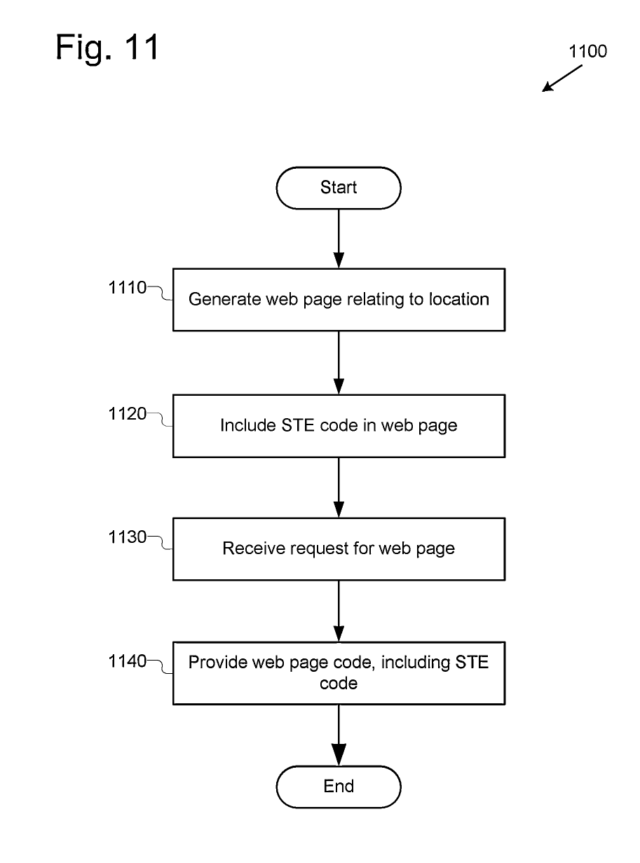

FIG. 11 illustrates an example shared-transportation user-interface element display process 1100, in accordance with various embodiments. In various embodiments, process 1100 may include one or more implementations of operation 920 of process 900. The process may begin at operation 1110, where the web page may be generated, such as by the web page generation module 820. Next, at operation 1120, the web page generation module 820 may include the code for the STE 800 in the web page 810. In alternative embodiments, the web page generation module 820 may include one or more links or references to separately-stored code for the STE 800 rather than including the code for the STE 800 directly in the web page. Next, at operation 1130, the web page generation module 820 (or a storage or server associated with the web page generation module 820) may receive a request for the web page 810. In response to this request, at operation 1140, the web page generation module 820 may then provide the web page code, including the code for the STE 800 (or a reference thereto). In alternative embodiments, the web page generation module 820 may not request provision of the STE 800 until after the request for the web page 810. In such embodiments, one or more of operations 1110 and 1120, as well as those of process 1000, may occur after receipt of a request for the web page 810. The process may then end.

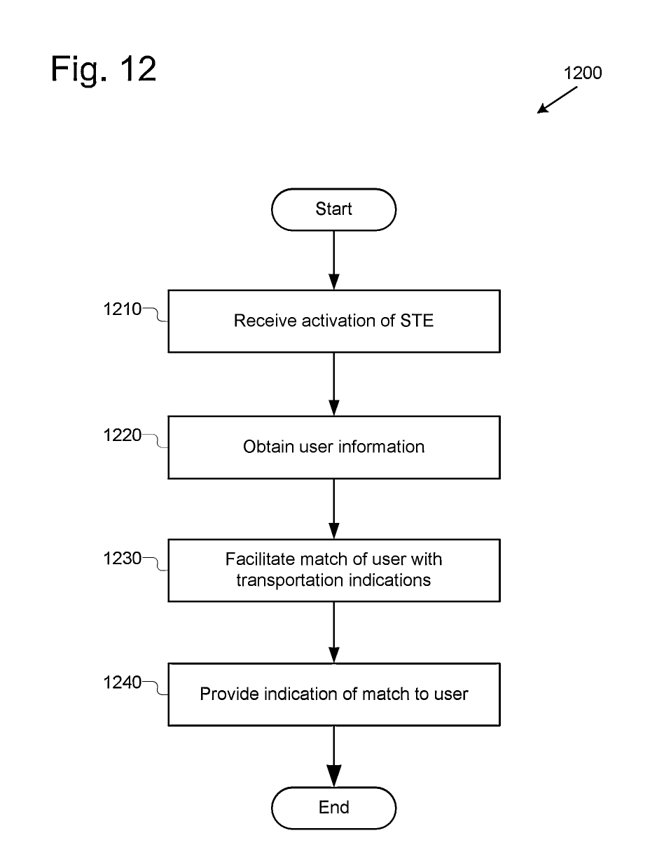

FIG. 12 illustrates an example shared-transportation user-interface element request process 1200, in accordance with various embodiments. In various embodiments, process 1200 may include one or more implementations of operation 930 of process 900. The process may begin at operation 1210, where the STE 800 may receive an activation by the user 105. In response to this activation, at operation 1220 the STE 800 may obtain user information for the user 105. In various embodiments, the STE 800 may be configured to display an interface for obtaining the user information, such as described above. In various embodiments, the STE 800 may obtain some user information from information contained on a local machine the STE 800 is executed on, such as by obtaining cookies or other locally-stored information. In some embodiments, the STE 800 may obtain user information from the shared-transportation storage 175.

Next, at operation 1230, the STE 800 may facilitate a match of the user 105 with an offer of (or an offer to accept) shared transportation to the location associated with the STE 800. In various embodiments, the matching may be performed by the shared-transportation matching module 150 in response to a request from the STE 800. In various embodiments, the matching may be performed with reference to one or more offers of shared transportation that have been previously secured by the vendor 880. In various embodiments, after the shared-transportation matching module 150 has identified a match for shared transportation, the STE 800 (or other notification module) may provide a notification of the match to the user 105. The process may then end.

The following examples may illustrate particular uses of the STE 800 to facilitate sharing of transportation. It may be recognized that no particular limitation is implied by these examples and that other embodiments may be described and claimed.

In one example, a restaurant owner (vendor 880) may create a web page 810, such as using web page generation module 820, relating to the owner's restaurant. The web page generation module 820 may then request, from the transportation-sharing code generation module 850, code for the STE 800. The restaurant owner may also separately provision offers of rides from one or more individuals for storage in the share-transportation data storage 175. Later, the user 105 may request the web page 810. During rendering of the web page 810, the STE 800 may be rendered, such as in the form of a button that says “PUSH TO RIDE” or other inviting phrase. The user 105 may then activate the STE 800. This activation will cause the code for the STE 800 to trigger a matching of shared transportation using the shared-transportation matching module 150. The matching may be between the user 105 and one of the individuals whom the restaurant owner had previously provisioned as ride-offerers.

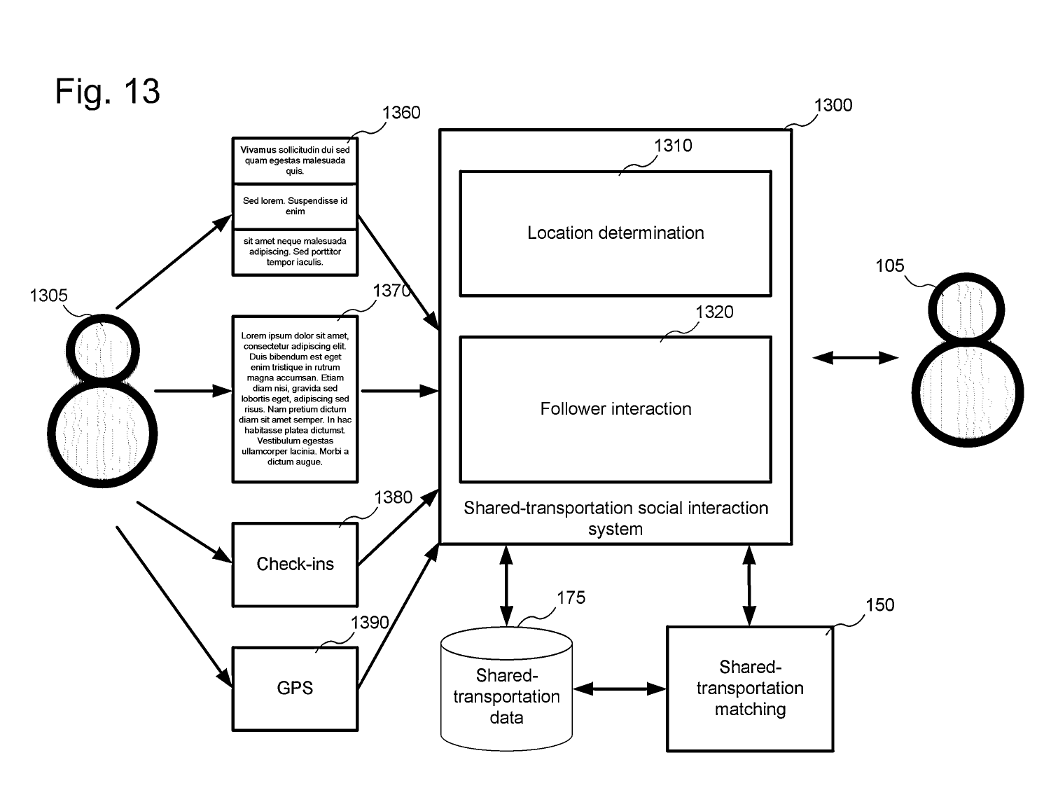

Referring now to FIG. 13, a shared-transportation social interaction system 1300 (“STSI 1300”) is illustrated. In various embodiments, the STSI 1300 may be configured to facilitate sharing of transportation based on statements or activities of a user 1305. Thus, the STSI 1300 may monitor statements of the user 1305 such as short-form broadcasts 1360 (e.g. tweets) or blog posts 1370 to determine one or more current or potential future locations for the user 1305. In some embodiments, the STSI 1300 may also be configured to determine one or more current or potential future locations based on data representing activities of the user 1305 such as social networking check-ins 1380 (e.g., Foursquare) or GPS data 1390. In various embodiments, the STSI may include a location determination module 1310 that may be configured to perform this monitoring of statements and/or activities of the user 1305 and the determination of the locations.

In various embodiments, by facilitating easier sharing of transportation based on locations associated with the user 1305, the STSI 1300 may be configured to encourage sharing of transportation by users. For example if user 105 is a friend of user 1305, he or she may wish to know when user 1305 is visiting town and may wish to know about transportation sharing opportunities during this time. In another example, user 105 may not personally know user 1305, but may be aware of user 1305's public persona and may appreciate user 1305's taste in events or venues. By following user 1305 using the STSI 1300, the user 105 may be able to identify transportation-sharing opportunities that are of interest to him or her.

In various embodiments, the STSI 1300 may be configured to alert one or more users, such as user 105, of current or potential future locations of the user 1305. In such embodiments the user 105 may then be facilitated in finding shared transportation with either the user 1305 or another user to one of these current and/or potential future locations. In various embodiments, this finding of shared transportation may be performed by the shared transportation matching module 150 in conjunction with the shared-transportation data storage 175, as described herein.

In various embodiments, the STSI 1300 may include a follower interaction module 1320 that is configured to maintain associations between users as “follower” associations. In various embodiments, a user, such as user 105, may become a “follower” of user 1305 if user 105 wishes to be alerted, when appropriate, as to relevant current or potential future locations of the user 1305. In various embodiments, the follower interaction module 1320 may be configured to facilitate creation of follower associations and to alert followers at relevant times. In various embodiments, the follower interaction module 1320 may be configured to allow fine-grained control over creation of follower associations based on preferences of the user 1305, who may be followed, and the user 105, who may be a follower. In various embodiments, these preferences may be stored on the shared-transportation data storage 175.

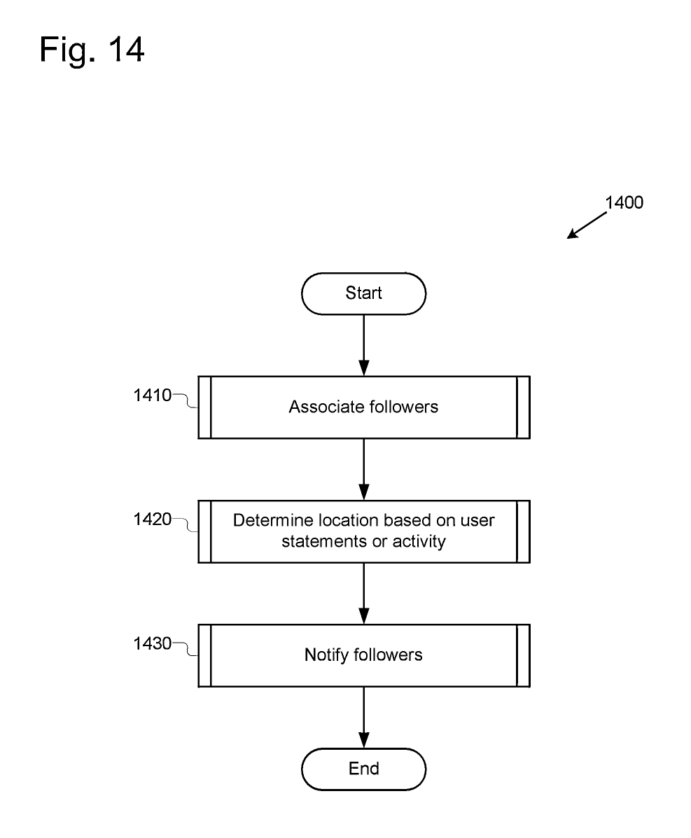

FIG. 14 illustrates an example shared-transportation social interaction process 1400, in accordance with various embodiments. The process may begin at operation 1410, where the STSI 1300 may associate one or more followers with the user 1305. In various embodiments, through operation 1410, one or more following associations may be created, as described above. This may facilitate notification of users, such as user 105, when user 1305 is at or will potentially be at a location of interest to the users. Particular embodiments of operation 1410 are discussed below. Next, at operation 1402, the STSI 1300 may determine one or more locations based on user 1305's statements or activities. Particular embodiments of operation 1420 are discussed below. Next, at operation 1430, the STSI 1300 may notify one or more of the followers, such as user 105, so that the followers may share transportation to the location determined at operation 1420. Particular embodiments of operation 1430 are discussed below. The process may then end.

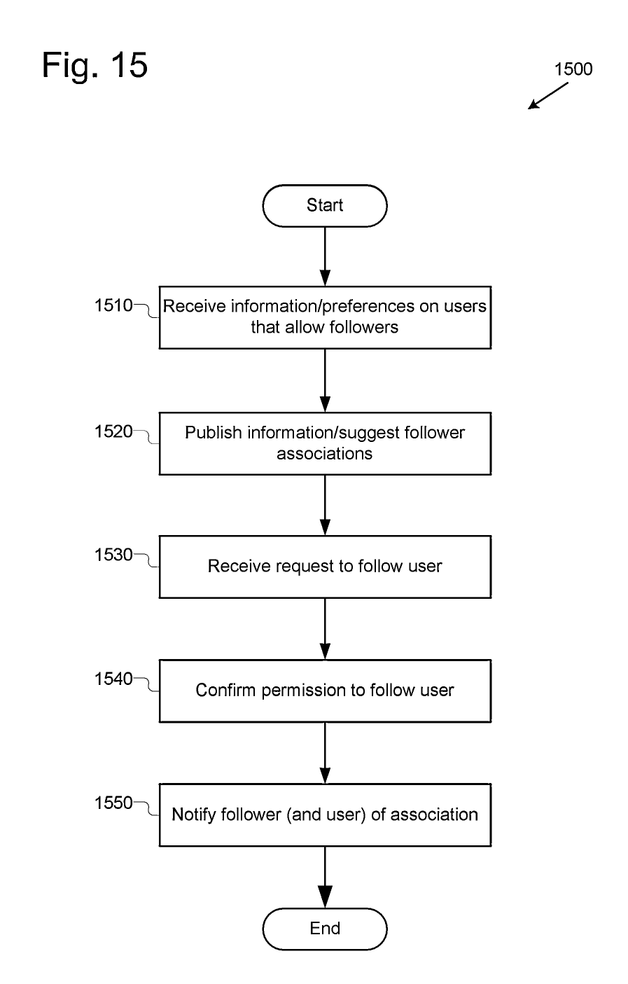

FIG. 15 illustrates an example social shared-transportation follower association process 1500, in accordance with various embodiments. In various embodiments, process 1500 may include one or more implementations of operation 1410 of process 1400. The process may begin at operation 1510, where the STSI 1300, and in particular, the location determination module 1310, may receive information and/or preferences about users that wish to allow followers, such as user 1305. In various embodiments, this information may include one or more links or credentials to social network services to allow the STSI 1300 to monitor the user 1305. In various embodiments, the STSI 1300 may also receive identifying and/or descriptive information about user 1305, including, but not restricted to a name, username, public handle, password, business information, hometown, and/or other information. In embodiments, some of this information may be designated as publically available for potential followers to see. In some embodiments, preferences received at operation 1510 may include the user 1305's preferences about granularity of location information to be released (e.g., city vs. address information), types of locations that may be released (e.g., public parks or speeches vs. restaurants), categories of persons that may become followers, times during which locations may be shared, etc. In embodiments, some or all of the information may be persisted on shared-transportation storage 175.

Next, at operation 1520, the STSI 1300 may publish some or all of the information received at operation 1510 and/or suggest follower associations. Thus, in embodiments, the follower interaction module 1320 of STSI 1300 may make the information available, such as on the Internet or in a dedicated application, for users, such as user 105, to review. In some embodiments, the follower interaction module 1320 may suggest follower associations to users. Thus, in various embodiments, the STSI 1300 may have knowledge of common interests or friends between the user 1305 and the user 105, such as based on knowledge of the users' social network profiles or activities. In such scenarios, the follower interaction module 1320 may suggest the user 1305 and the user 105 start a follower association.

At operation 1530, the STSI 1300 may receive a request, such as from user 105 to follow user 1305. In various embodiments, this request may be made by the user 105 after reviewing information published by the follower interaction module 1320. In various embodiments, the request may contain information identifying the user 105 in order that the user 1305 may review the request.

Next, at operation 1540, the follower interaction module 1320 may confirm permission for the user 105 to follow the user 1305. In various embodiments, the follower interaction module 1320 may send a message, such as a text message, email, or tweet, to the user 1305 describing the user 105 as well as the user's request. In various embodiments, information describing the user 105 may be taken from the user's request and/or may be obtained from the shared-transportation storage 175. Next, at operation 1540, if the user 1305 has confirmed that the user 105 may follow him or her, at operation 1550, the two users 1305 and 105 may be notified of the follower association, such as by email, text message, and/or tweet. The process may then end.

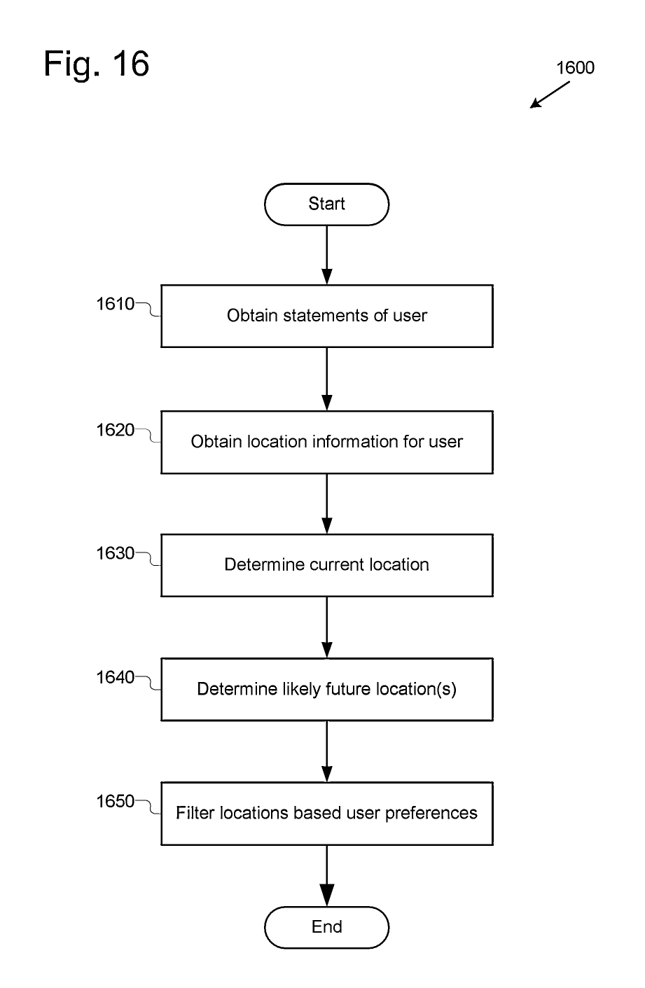

FIG. 16 illustrates an example shared-transportation social location determination process 1600, in accordance with various embodiments. In various embodiments, process 1600 may include one or more implementations of operation 1420 of process 1400. The process may begin at operation 1610, where the location determination module 1310 of STSI 1300 may obtain one or more statements of the user 1305. As discussed above, in embodiments, the location determination module 1310 may obtain these statements by monitoring of public and/or private blogs, microblogs, and other social networking ecosystems. In various embodiments, these statements may be stored, such as at the shared-transportation storage 175.

Next, at operation 1620, the location determination module 1310 may obtain location information for the user. In various embodiments, the location determination module 1310 may obtain location information by obtaining metadata from statements obtained at operation 1610 describing the location where the statements are made. In other embodiments, the location determination module 1310 may obtain location information from a GPS device used by the user 1305. In various embodiments, the location determination module 1301 may also obtain location information using information recorded at social networking sites, such as by monitoring check-ins at different venues by the user 1305. In various embodiments, this location information may be stored, such as at the shared-transportation storage 175.

Next, at operation 1630, the location determination module 1310 may determine a current location for the user. In various embodiments, this determination may be performed by comparing the information obtained at operations 1610 and 1620. Next, at operation 1640, the location determination module 1310 may determine a potential future location for the user. In various embodiments, the location determination module 1310 may determine a potential future location based on a statement of time made by user 1305. In various embodiments, the location determination module 1310 may determine a potential future location based on a past history of the user 1305. For example, if the user 1305 has previously gone between locations A, B, and C in a particular order on multiple occasions, and the user is currently at A and has tweeted that he is going to B, the location determination module 1310 may determine that the user is likely to go to both B and to C. In other embodiments, the location determination module 1310 may compare the received location information and statements to other users' past location information and statements to make the determination. In other embodiments, the location determination module 1310 may compare previously-determined locations for the user to determine that the user 1305 will be travelling in a particular direction or along a particular road. Thus, the location determination module 1310 may determine that the user 1305 may be travelling to a town or restaurant found along the road.

Next, at operation 1650, the locations determined at operations 1630 and 1640 may be filtered according to one or more preferences of the user 1305. Thus, in embodiments, if the user 1305 desires that only city-level location information be released for the user, more specific information may be filtered out. Similarly, if the user has previously indicated that location information may not be released during certain times, locations may be filtered appropriately. The process may then end.

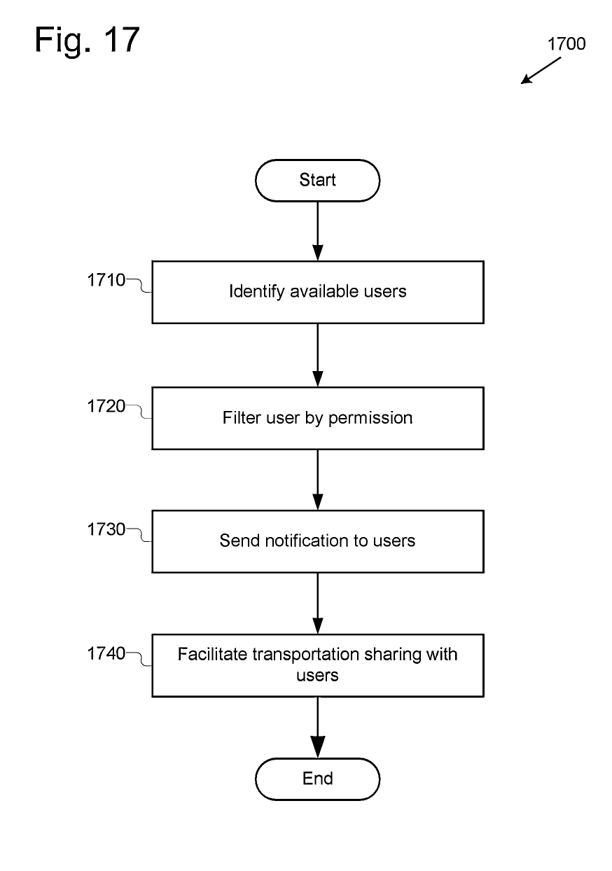

FIG. 17 illustrates an example shared-transportation social location notification process 1700, in accordance with various embodiments. In various embodiments, process 1700 may include one or more implementations of operation 1430 of process 1400. In various embodiments process 1700 may be performed with reference to a location determined by the location determination module 1310 during operation of process 1600.

The process may begin at operation 1710, where the follower interaction module 1320 may identify available users. In various embodiments, the follower interaction module 1320 may determine users to be available when they are proximate to the determined location. In various embodiments, users may be determined to be proximate based both on users' current distance from the location as well as preferences of user 1305 as well as the users that are following user 1305. In various embodiments, the follower interaction module 1320 may also consider scheduling information for the users to determine users that do not have schedule conflicts with either the current location or a potential future location. In various embodiments, the follower interaction module 1320 may determine if the users have particular categories of availability, such as recreational or business availability, as well. In various embodiments, additional information may be considered when determining availability, such as weather (near the location and/or near the users) or traffic data.

Next, at operation 1720, the follower interaction module 1320 may filter the users may permission. Thus, in various embodiments, the follower interaction module 1320 may filter out one or more users based on preferences of the user 1305. Next, at operation 1730, the follower interaction module 1320 may send a notification to the filtered users of the determined location. In various embodiments, this notification may include an email, text, or other notification. In other embodiments, the notification may include the display of the location on a map, such as described above.

At operation 1740, the follower interaction module 1320 may then facilitate transportation sharing between the users based on the determined location. Thus, in some embodiments, the follower interaction module 1320 may provide, in the notification, a link or other code to allow the users to request shared transportation to the determined location. In various embodiments, the follower interaction module 1320 may facilitate shared transportation between the various users; in other embodiments, the follower interaction module 1320 may facilitate shared transportation between the user 1305 and one or more of the users following user 1305. The follower interaction module 1320 may base this facilitation on the preferences of the user 1305. The process may then end.

The following examples may illustrate particular uses of the STSI 1300 to facilitate sharing of transportation. It may be recognized that no particular limitation is implied by these examples and that other embodiments may be described and claimed. In one example, a user 105 may publish information one or more public sites, including blogs and Twitter™. A friend (user 1305), who lives in a different town than the user 105 may wish to see the user 105 when the user 105 is in the same town. The user 105 may register with the STSI 1300 to share his or her location information; this registration may then be discovered by the user 1305, who may request to follow the user 105. The user 105 may then approve the following of the user 1305. The STSI 1300 may then monitor statements of the user 105 for identification of locations for which the user 1305 may wish to share transportation to. Later, when the user 105 is planning to visit the town of the user 1305, the user 105 may blog about his intensions. The STSI 1300 may identify that the user 105 is likely to visit the town and may send a notification to the user 1305. Later, when the user 105 has visited a specific sporting event, the STSI 1300 may determine that the user 105 is visiting that event, such as through information gained from his GPS or through social networking check-ins. The STSI 1300 may then notify the user 1305 of the specific location of the user 105 and may facilitate matching of transportation for the user 1305 to the event. Other examples may be described and claimed.

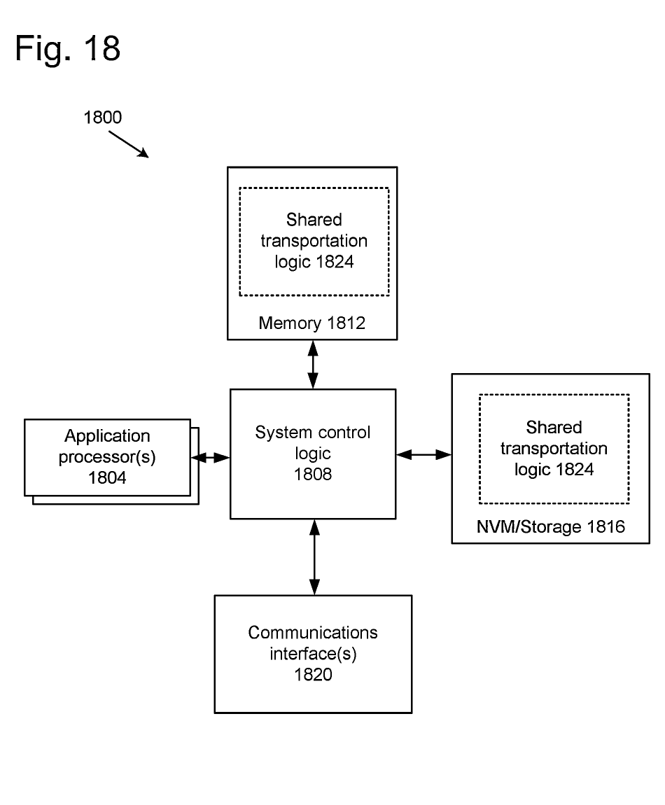

FIG. 18 illustrates, for one embodiment, an example computer system 1800 suitable for practicing embodiments of the present disclosure. As illustrated, example computer system 1800 may include control logic 1808 coupled to at least one of the processor(s) 1804, system memory 1812 coupled to system control logic 1808, non-volatile memory (NVM)/storage 1816 coupled to system control logic 1808, and one or more communications interface(s) 1820 coupled to system control logic 1808. In various embodiments, the one or more processors 1804 may be a processor core.

System control logic 1808 for one embodiment may include any suitable interface controllers to provide for any suitable interface to at least one of the processor(s) 1804 and/or to any suitable device or component in communication with system control logic 1808.

System control logic 1808 for one embodiment may include one or more memory controller(s) to provide an interface to system memory 1812. System memory 1812 may be used to load and store data and/or instructions, for example, for system 1800. In one embodiment, system memory 1812 may include any suitable volatile memory, such as suitable dynamic random access memory (“DRAM”), for example.

System control logic 1808, in one embodiment, may include one or more input/output (“I/O”) controller(s) to provide an interface to NVM/storage 816 and communications interface(s) 1820.

NVM/storage 1816 may be used to store data and/or instructions, for example. NVM/storage 1816 may include any suitable non-volatile memory, such as flash memory, for example, and/or may include any suitable non-volatile storage device(s), such as one or more hard disk drive(s) (“HDD(s)”), one or more solid-state drive(s), one or more compact disc (“CD”) drive(s), and/or one or more digital versatile disc (“DVD”) drive(s), for example.

The NVM/storage 1816 may include a storage resource physically part of a device on which the system 1800 is installed or it may be accessible by, but not necessarily a part of, the device. For example, the NVM/storage 1816 may be accessed over a network via the communications interface(s) 1820.

System memory 1812 and NVM/storage 1816 may include, in particular, temporal and persistent copies of shared transportation logic 1824. The shared transportation logic 1824 may include instructions that when executed by at least one of the processor(s) 1804 result in the system 1800 practicing one or more of the operations described above for MTSS, STE and/or STSI. In some embodiments, the shared transportation logic 1824 may additionally/alternatively be located in the system control logic 1808.

Communications interface(s) 1820 may provide an interface for system 1800 to communicate over one or more network(s) and/or with any other suitable device. Communications interface(s) 1820 may include any suitable hardware and/or firmware, such as a network adapter, one or more antennas, a wireless interface, and so forth. In various embodiments, communication interface(s) 1820 may include an interface for system 1800 to use NFC, optical communications (e.g., barcodes), BlueTooth or other similar technologies to communicate directly (e.g., without an intermediary) with another device.

For one embodiment, at least one of the processor(s) 1804 may be packaged together with system control logic 1808 and/or shared transportation logic 1824 (in whole or in part). For one embodiment, at least one of the processor(s) 1804 may be packaged together with system control logic 1808 and/or shared transportation logic 1824 (in whole or in part) to form a System in Package (“SiP”). For one embodiment, at least one of the processor(s) 804 may be integrated on the same die with system control logic 1808 and/or shared transportation logic 1824 (in whole or in part). For one embodiment, at least one of the processor(s) 1804 may be integrated on the same die with system control logic 1808 and/or shared transportation logic 1824 (in whole or in part) to form a System on Chip (“SoC”).

Computer-readable media (including non-transitory computer-readable media), methods, systems and devices for performing the above-described techniques are illustrative examples of embodiments disclosed herein. Additionally, other devices in the above-described interactions may be configured to perform various disclosed techniques.

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. This application is intended to cover any adaptations or variations of the embodiments discussed herein. Therefore, it is manifestly intended that embodiments described herein be limited only by the claims.

Where the disclosure recites “a” or “a first” element or the equivalent thereof, such disclosure includes one or more such elements, neither requiring nor excluding two or more such elements. Further, ordinal indicators (e.g., first, second or third) for identified elements are used to distinguish between the elements, and do not indicate or imply a required or limited number of such elements, nor do they indicate a particular position or order of such elements unless otherwise specifically stated.

What is claimed is:

1. A computer-implemented method for facilitating sharing of transportation, the method comprising:
receiving, by one or more logic modules operated by a computing device, a selection of a location on a displayed map; and
facilitating, by the computing device, association of the location on the map with an indication to offer or accept user-provided transportation to that location.

2. The method of claim 1, further comprising displaying, by the computing device, the displayed map.

3. The method of claim 1, further comprising providing, by the one or more logic modules, an interface for receiving identification of the location from a user.

4. The method of claim 3, wherein providing the interface for identification of the location on the map comprises:
presenting a listing of locations associated with the map; and
providing a facility for the user to select a location from the listing.

5. The method of claim 3, wherein providing the interface for identification of the location on the map comprises providing a facility for a user to select an event occurring at the location.

6. The method of claim 1, further comprising providing, by the one or more logic modules, an interface for a user to indicate the offer or acceptance of user-provided transportation to the location.

7. The method of claim 6, wherein the interface is configured to receive an indication that the user wishes to select transportation sharing as a choice for a route to the location.

8. The method of claim 1, wherein the computing device comprises a first computing device and wherein the method further comprises matching, by a second computing device, a first user who intends to provide transport to the location with a second user who desires to receive transport to the location.

9. The method of claim 2, wherein displaying the map comprises displaying one or more previously-received indications of offers or acceptances of user-provided transport on the map.

10. The method of claim 9, wherein displaying the one or more previously-received indications of offers or acceptances of user-provided transport comprises:
modifying the map to include the one or more previously-received indications; and
displaying the modified map.

11. The method of claim 1, further comprising facilitating, by the one or more logic modules, display of one or more users associated with one or more offers or acceptances of transportation sharing.

12. An apparatus for facilitating the sharing of user-provided transport, the apparatus comprising:
one or more computer processors; and
one or more logic modules configured to be operated by the one or more computer processors to:
provide an interface for receiving identification of a location on a displayed map from a user;
receive an identification of the location from the user; and
facilitate association of the location on the map with an indication to offer or accept user-provided transportation to that location.

13. The apparatus of claim 12, wherein the one or more logic modules are further configured to be operated by the one-or-more processors to display the map.

14. The apparatus of claim 13, wherein the one or more logic modules are further configured to be operated by the one-or-more processors to facilitate a match between a first user who intends to provide transport to the location and a second user who desires to receive transport to the location.

15. The apparatus of claim 12, wherein the one or more logic modules are further configured to display one or more previously-received indications of offers or acceptances of user-provided transport on the map through:
modification of the map to include the one or more previously-received indications; and
display of the modified map.

16. The apparatus of claim 12, wherein the one or more logic modules are further configured to facilitate display of one or more users associated with one or more offers or acceptances of transportation sharing

17. One or more computer-readable media comprising instructions stored thereon that are configured to cause a computing device, in response to execution of the instructions, to:
provide an interface for receiving identification of a location on a displayed map from a user;
receive an identification of the location from the user; and
facilitate association of the location on the map with an indication to offer or accept user-provided transportation to that location.

18. The computer-readable media of claim 17, wherein instructions are further configured to cause the computing device, in response to execution, to display the map.

19. The computer-readable media of claim 17, wherein instructions are further configured to cause the computing device, in response to execution, to facilitate a match between a first user who intends to provide transport to the location and a second user who desires to receive transport to the location.

20. The computer-readable media of claim 17, wherein instructions are further configured to cause the computing device, in response to execution, to display one or more previously-received indications of offers or acceptances of user-provided transport on the map through:
modification of the map to include the one or more previously-received indications; and
display of the modified map.
